(19) United States
(12) Patent Application Publication
(10) Pub. No.: US 2004/0154249 A1
(43) Pub. Date: Aug. 12, 2004

(54) Method and apparatus for securing tiles to curtain wall mullions

(76) Inventor: Arturo Mastelli, Coral Gables, FL (US)

Correspondence Address: DICKINSON WRIGHT PLLC, 1901 L. STREET NW, SUITE 800, WASHINGTON, DC, 20036, US

(21) Appl. No.: 10/770,917

(22) Filed: Feb. 3, 2004

Related U.S. Application Data
(63) Continuation of application No. 09/824,661, filed on Apr. 4, 2001.

(51) Int. Cl. E06B 3/54

(52) U.S. Cl. 52/474

(57) ABSTRACT

The present invention relates to a method and apparatus for securing porcelain and ceramic tiles to curtain wall mullions comprising the use of structural panels made of light-weight but rigid materials, such as aluminum. The tiles are preferably secured to the panels using structural silicone, and secured to the frame using components such as tile retainers, stops, gaskets and sealants. The frame is preferably made of snap-together members and supported by building structures to withstand lateral loads, such as caused by heavy wind pressure and flying debris.

### BACKGROUND OF THE INVENTION

Buildings constructed in certain areas of the country, such as in the Southeastern states, are often subjected to extreme weather conditions, including hurricanes and gale force winds. Building codes in these areas are often strict to ensure that the buildings that are constructed can withstand these conditions. For example, many building codes require exterior walls to be constructed in a manner that resists wind blown debris and high wind pressures, such as by requiring that they be able to resist lateral loads of up to 75 pounds per square feet. In areas where the threat of hurricane damage is especially high, tests must also be conducted requiring walls to resist the impact of a two by four inch piece of wood, nine feet long and weighing nine pounds, striking the exterior wall (like a missile) at 35 miles per hour or 50 feet per second.

Porcelain and ceramic tiles are sometimes used on exterior walls because of their aesthetic value and long lasting durability. In areas where the threat of hurricane damage exists, however, the ability to use such tiles is limited because of the difficulty of making the walls strong enough to meet the strict building code requirements. Although it is possible to use such materials, the tiles. must be thick and strong enough to satisfy the requirements, thereby increasing construction costs. Not only must larger and more expensive tiles be used, but the additional costs associated with having to transport, lift and install larger and heavier pieces can be burdensome. Although technological advancements have made it possible to manufacture porcelain and ceramic tiles that are stronger in tensile strength than in the past, the difficulty in meeting the strict requirements still exists for applications in many areas of the country.

What is needed, therefore, is a method and apparatus for securing porcelain and ceramic tiles to curtain wall mullions that enhances the strength of the walls without necessarily increasing the cost and weight, so that the strict building code requirements that exist in areas where the threat of hurricane damage is high can be satisfied.

### SUMMARY OF THE INVENTION

The present invention relates to an improved method and apparatus for securing porcelain and ceramic tiles to curtain wall mullions to satisfy the strict building code requirements that exist in areas where the threat of hurricane damage is high. In existing curtain wall structures using mullions, there is typically a support frame made of horizontal and vertical framing members, such as made of metal or aluminum, which are spaced a predetermined distance apart from one another, i.e., to form a structural frame on which the exterior tiles can be applied. The frame is typically sized so that it can fit between floors, extending from one floor to the next floor, and in numbers sufficient to extend around the exterior periphery of the building. Where the upper floor is the top of the building, the frame can also be cantilevered above the upper floor. In a typical curtain wall application, the spacing between the mullions is anywhere between 2-3 feet.

The curtain wall of the present invention is preferably constructed using prefabricated framing members such as those that can be snapped into place using a minimum number of fasteners. For example, each of the vertical mullions can be constructed from male and female mullion halves which snap together along their edges to form a substantially rectangular tube-like member. Likewise, the horizontal mullions can come in two pieces, which allows fasteners to be installed from inside. That is, an opening can be provided along the mullion member, and provided with a removable cover plate, so that fasteners, such as nuts and bolts, can connect the member to other structural members from the inside. On the other hand, the present invention can be constructed using virtually any type of framing members sufficient to support the tiles thereon in the manner discussed.

Additional members, such as tile retainers, retaining covers, and tile stops, may also be used to facilitate the attachment of the tiles to the frame. In this respect, a tile retainer is preferably provided along the upper and side edges of the tiles along the upper and side portions of the frame. A retaining cover is then used to hide the tile retainer, which can be secured to the frame using fasteners such as nuts and bolts. Tile stops can also be provided along the lower tile edges to support the weight of each tile. These stops are preferably secured to the mullions and extend outwardly so that the tiles can rest thereon. Gaskets and other sealants can be used around the periphery of the tiles to secure and seal the tiles to the frame.

In one aspect of the present invention, structural panel inserts, such as made of light weight aluminum, are provided within the spaces between the mullions. Square or rectangular panels can be sized and fitted into the spaces formed by the mullions and secured using conventional fasteners such as nuts and bolts. The structural panels are preferably thin but strong enough to provide reinforcement against lateral loads and impact from debris. The panels preferably have angled edges extending a predetermined distance rearwardly from the front of the panels to provide rigidity and support. The angled edges preferably extend around the perimeter of each panel and provide support against lateral loads.

Another aspect of the present invention is that the porcelain and ceramic tiles that are used are relatively thin in comparison to the tiles that have been used in the past for such curtain wall applications. In the preferred embodiment, the tiles can be as thin as about ⅜ inch, thereby making each tile relatively light-weight and easy to handle. Each tile is also cut and sized to fit over the spaces formed by the horizontal and vertical mullions, and extended about half-way over each of the mullions so that proper attachment and support can be provided by the frame.

Another feature of the present invention is that structural silicone is preferably used as a means of securing the tiles to the frame and/or the structural panels. Structural silicone has adhesive properties which enable the tiles to be glued to the frame, and has elastic properties which help to cushion the tiles in relation to the frame while providing spacing therebetween. The structural silicone can be applied directly to the structural panels, as well as along the edges of the mullions, to properly seal and secure the tiles to the frame. Additional gaskets can also be applied along the edges of the tiles and frame to ensure that the walls are wind and moisture resistant.

In the preferred embodiment, the tiles are fully secured to the frame without any evidence of any mechanical or structural fasteners from the exterior. That is, the structural silicone is preferably placed behind the tiles so that they are hidden from view, and the gaskets and other sealants are preferably placed behind and/or along the edges of the tiles so that they are substantially hidden. The retaining components are also preferably extended around the periphery of the wall so that they are visually integrated with the building structure. Retainer covers can also be used to hide the retainer components. These features enhance the aesthetic appearance of the curtain wall of the present invention, thereby maximizing the benefits of the porcelain and ceramic tiles that are used, and the designs that are provided thereon.

The use of the structural panels behind the tiles, in combination with the structural silicone, enables the curtain wall structure of the present invention to provide additional strength and resistance against lateral loads due to wind and impacts due to wind blown debris. This is particularly important in areas where the threat of hurricane damage is high, such as in the Southeastern areas of the United States. The use of the relatively thin tiles and the relatively light-weight panels allows for the construction of the walls to be rapid and cost-effective. The ability to reduce the thickness of the tiles allows the curtain wall of the present invention to be manufactured at a lower cost than in previous designs.

### BRIEF DESCRIPTION OF DRAWINGS

FIG. 1 is a typical front elevation view of the curtain wall mullion frame of the present invention with horizontal and vertical mullions;

FIG. 2 is a side cross-section view of the curtain wall of the present invention showing various details;

FIG. 3 is a horizontal section view from above of the curtain wall of the present invention showing various details;

FIG. 4 is a typical side cross-section detail view of a joint near the upper edge of the curtain wall of the present invention;

FIG. 5 is a side cross-section view of a cantilevered embodiment of the curtain wall of the present invention;

FIG. 6 is a typical side cross-section detail view of a connection between the tile and frame along one of the joints of the curtain wall of the present invention;

FIG. 7 is a horizontal section detail view from above of a connection between the wall and horizontal support member;

FIGS. 8a through 8h are cross-section views of the various members that are used to construct the curtain wall of the present invention; and

FIG. 9 is a an exploded perspective view of the connection between the horizontal and vertical mullions used in the curtain wall of the present invention.

### DETAILED DESCRIPTION OF THE INVENTION

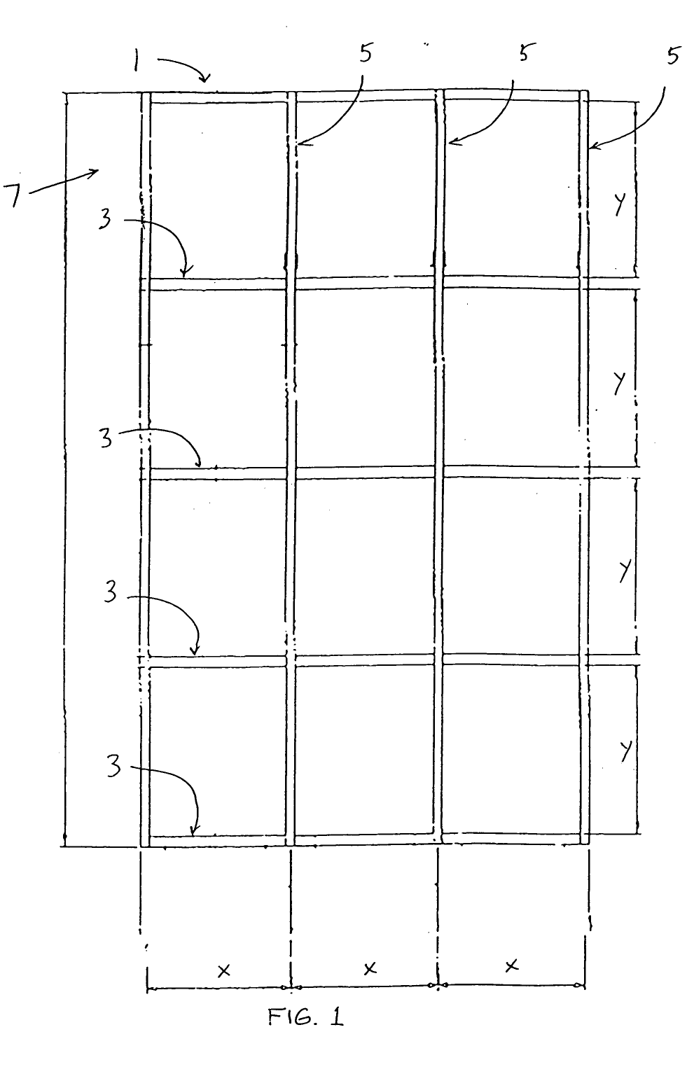

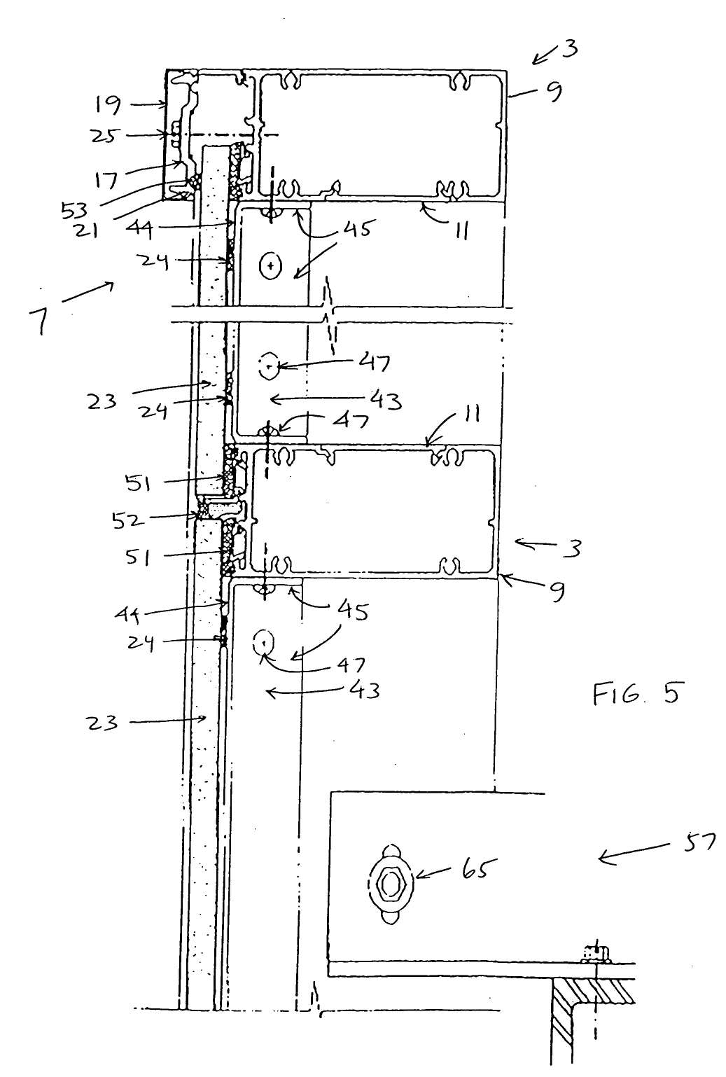

FIG. 1 represents an elevation view of a typical mullion frame 1 having horizontal 3 and vertical 5 members that are spaced apart a predetermined distance, x and y, respectively. The horizontal and vertical members 3 and 5 are preferably made of structurally rigid but light-weight materials, such as aluminum, and are preferably connected together by conventional means to form a substantially rigid frame 1. Each frame 1 is intended to span the vertical distance between two sections of the building, such as between two floors, wherein the bottom of the frame can be connected to one floor, and the upper part of the frame can be connected to the floor above it. When the frame 1 is used along the top of a structure, the top section 7 of the frame can be cantilevered above the top floor, as shown in FIG. 5. The maximum distance between each mullion, x and y, in both horizontal and vertical directions, is preferably about 3 feet, although spans which provide the appropriate structural support can be provided where appropriate.

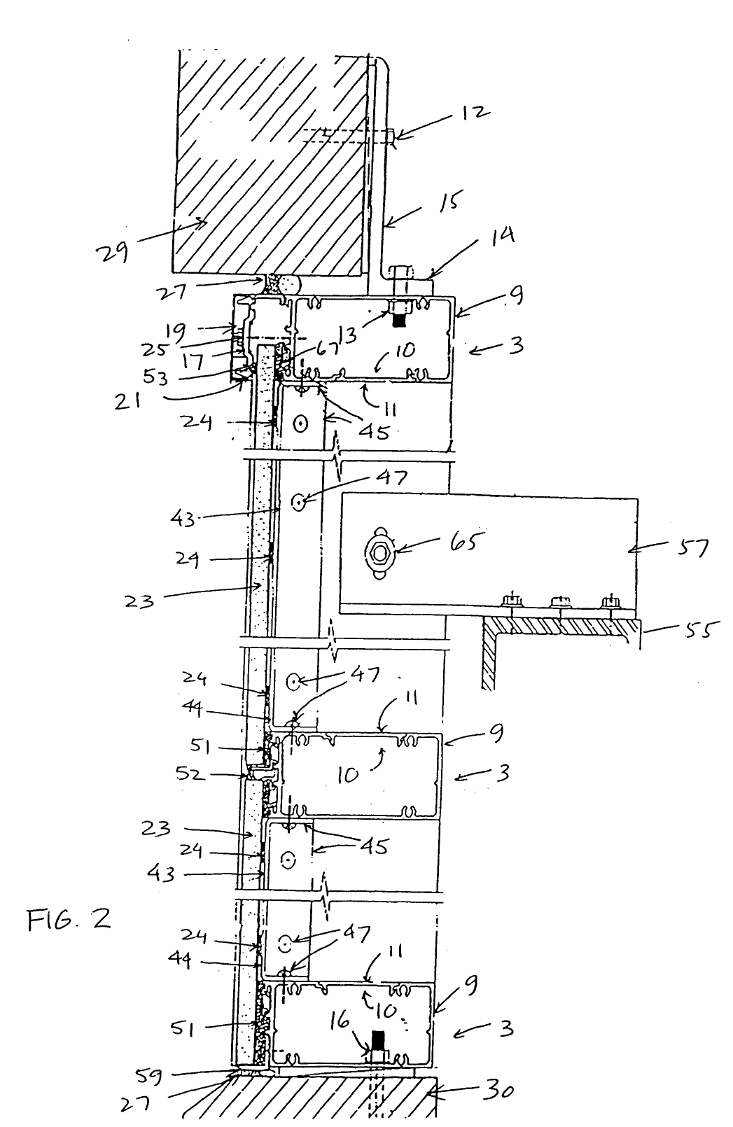

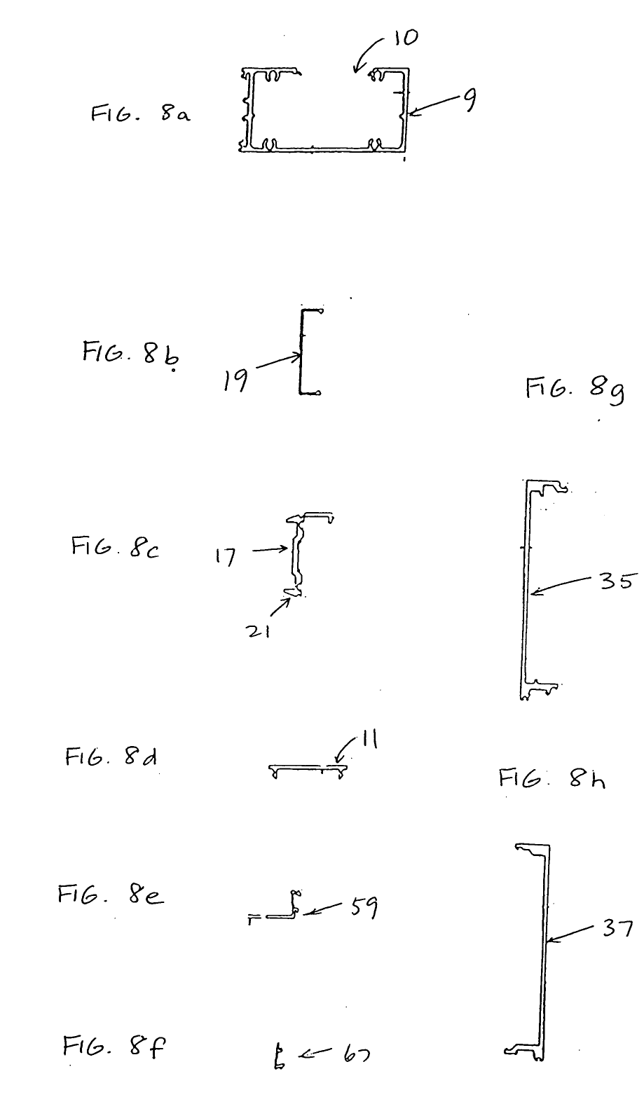

Each of the horizontal 3 and vertical 5 members are, in the preferred embodiment, made of extruded aluminum or other metal, and comprise multiple pieces which can be snapped together for ease of construction. These members can, however, be made in any conventional manner without departing from the present invention. For example, the horizontal members 3 are preferably made of a rectangular tube portion 9 with an opening 10 therein covered by a removable cover plate 11, which can be snapped into the tube portion 9 to seal the opening 10, as shown in FIG. 2. Being able to remove the cover plate 11 from the tube portion 9 enables construction workers to access the interior of the tube portion 9 so that fasteners 13 or 16, such as nuts and bolts, can be tightened from inside. A cross section detail view of the tube portion 9 is shown in FIG. 8a, and the snap-in cover plate 11 is shown in FIG. 8d.

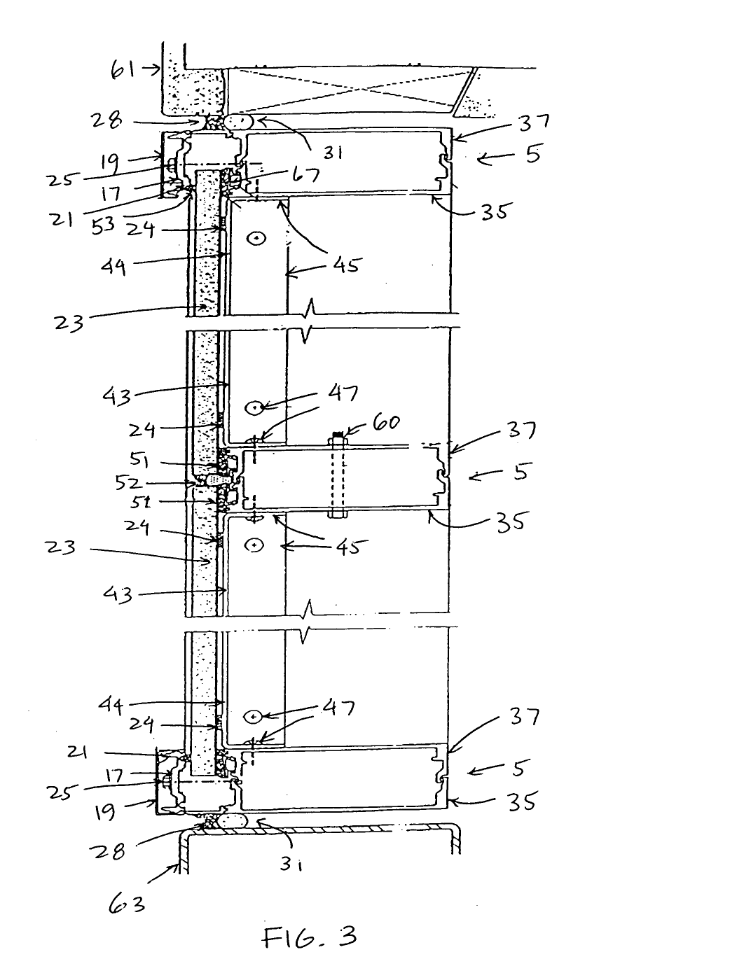

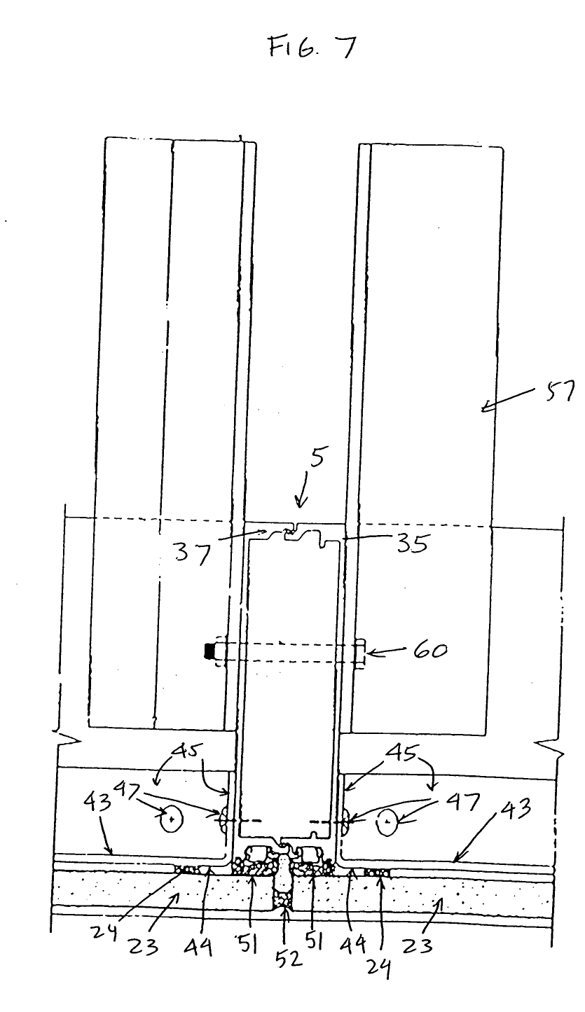

In FIG. 3, the preferred vertical members 5 of the frame 1 are shown in cross-section. Each vertical member 5 is preferably comprised of two halves, one a male mullion portion 35, as shown in FIG. 8g, and the other half a female mullion portion 37, as shown in FIG. 8h. These halves are preferably adapted so that they can be snapped together, as shown in FIG. 3, wherein the two halves 35, 37 can form a single tube-like member 5. Each of these vertical members 5 are adapted to extend substantially the height of each frame. They can also be extended above the upper floor to form a cantilever 7, as shown in FIG. 5. One or more nuts and bolts 60 are preferably provided at about midspan on each vertical mullion, as shown in FIGS. 3 and 7, to help keep the two halves together and prevent buckling.

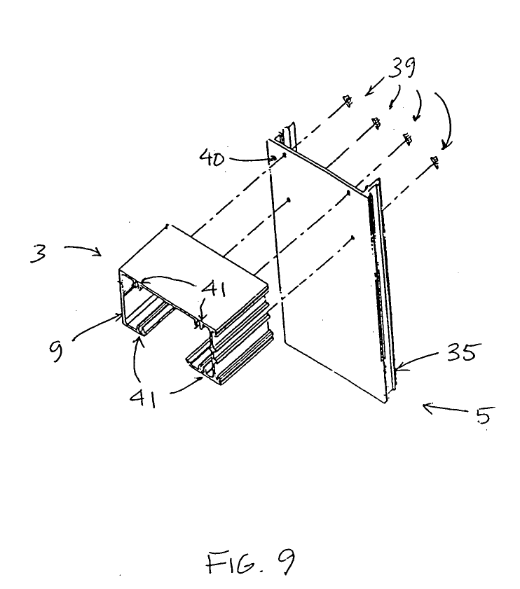

To form the frame 1, the horizontal mullions 3 are secured to the vertical mullions 5 at predetermined locations forming a grid pattern as shown in FIG. 1. To make the connections, frame assembly screws 39, as shown in FIG. 9, can be inserted through holes 40 drilled in the vertical mullions 5 and extended into screw receiving portions 41 on the horizontal mullions 3. The ability of the vertical muillion halves 35 and 37, and horizontal mullion members 9 and 11, to be separated, enables workers to access the interior spaces inside the mullions to install and tighten the fasteners as discussed.

For each frame 1, the maximum spacing x between the horizontal mullion members 3 is preferably about three feet, and the maximum spacing y between the vertical mullions members 5 is also preferably about three feet. Using the maximum spacing, the maximum preferred dimensions of the spaces between the horizontal 3 and vertical 5 mullions is about three feet by three feet, or constitutes an area of about nine square feet. In existing curtain wall structures, these spaces are required to be spanned by the exterior surface, such as by the tiles themselves.

As shown in FIGS. 2 through 7, one of the improvements provided by the present invention is the use of structural panels 43, that are preferably provided within the spaces between the mullions 3 and 5. These panels 43 provide structural strength, rigidity and support for the porcelain and/or ceramic tiles 23 that are to be positioned on the front. The structural panels 43 are preferably made of a strong, but light-weight material, such as aluminum, which can be made relatively thin, but which can also provide structural strength and rigidity to the frame 1. The structural panels 43 preferably have an angled edge 45, as shown in FIGS. 2 through 7, that extends around the perimeter of the panels. The angled edge 45 is preferably extended a predetermined distance rearward from the front surface 44 of the panels 43, i.e., in a direction normal to the panels, to provide support and reinforcement against lateral loads. The panels 43 themselves are preferably relatively thin, i.e., as little as ⅛ inch in thickness, in the preferred embodment.

The structural panels 43 are preferably secured to the horizontal 3 and vertical 5 mullions with bolts or screws or other fasteners 47, as shown in FIGS. 2 through 7, in a manner sufficient to support the panels thereto, such as every 12 inches on center. The fasteners 47 can be extended through holes drilled in the angled edges 45 and into the mullions 3 and 5, so that the panels 43 are supported by the edges 45.

As shown in FIG. 2, the tiles 23 are preferably secured to the front of the frame 1 in the manner discussed. The preferred method of securing the tiles 23 to members of the frame 1, including the structural panels 43 and mullions 3 and 5, is by using structural silicone 24, such as GE 4000 silicone manufactured by General Electric. Preferably the silicone 24 is applied in a ½ inch diameter bead, at about 8 inches on center, along the front surface of the structural panels 43. The tiles 23 can be positioned on the panels 43 and adhered thereto. The silicone 24 provides a means of adhering the tiles 23 to the panels 43, but also cushions the lateral loads that may be applied to the wall. An interior glazing gasket 51, as well as the silicone 24, can be provided around the perimeter of the tiles 23 to seal the spaces between the tiles 23 and mullions 3 and 5, and to provide support therefore. Between adjacent tiles 23, additional glazing compounds 52 can be used to seal the space or gap therebetween.

Along the upper and side edges of the frame 1, the tiles 23 are preferably held by retainers 17 extending from the mullions 3 and 5. In this respect, the front portion of each mullion 3 and 5 preferably has snap fittings upon which the tile retainers 17 can be secured. The tile retainer 17 is preferably used only along the upper and side edges of the curtain wall to retain and seal the perimeter edges of the tiles 23 as shown. In the horizontal members 3, the tile retainer 17 is preferably configured to snap into the front of the tube portion 9 along the top edge thereof, and has a retaining portion 21 which can be used to retain the upper edges of the tiles 23 in place. A snap-in filler 67 is provided that can be attached to the lower front portion of the mullions 3, to fill the space between the mullions 3 and tiles 23.

In the vertical members 5, the tile retainer 17 is preferably configured to snap into the female half 37 along the side edges thereof, and has a retaining portion 21 which can be used to retain the side edges of the tiles 23 in place in a similar manner. The snap-in fillers 67 can be attached to the front of the mullions 5, to fill the spaces between the mullions 5 and tiles 23.

The tile retainer 17 is preferably secured to the mullions 3 and 5 by a fastener 25, such as a nut and bolt, extending through the retainer 17, and the front of the mullions 3 and 5. A retainer cover 19 is preferably adapted to be snap fitted onto the tile retainer 17 to cover the fastener 25 and provide the desired aesthetic appearance. An exterior glazing gasket 53 can be provided along the outer edges of the tiles between the tile retainer 21 and tiles 23, as shown in FIGS. 2 through 5.

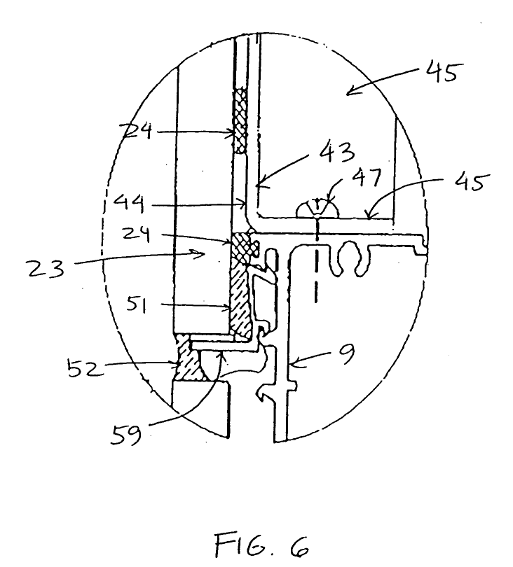

Along the lower edges of the tiles 23, and along the lower edge of the frame 1, there is preferably a tile stop 59, as shown in FIGS. 2 and 6, extending from the horizontal mullions 3. The stop 59 essentially snaps into and extends outward from the mullions 3 and provides a ledge upon which the tiles 23 can be positioned and supported. The stops 59 and mullions 3 are preferably adapted so that the stops 59 can snap into the front of the mullions 3 as shown in FIG. 6. Additional interior gaskets 51 can be used to fill and seal the spaces between the stops 59 and tiles 23. The gaskets 51 can provide a cushion effect for the tiles 23. Additional structural silicone 24 can also be used to seal the joints.

As shown in FIG. 2, the structural panels 43 are positioned such that they provide structural support laterally for the tiles 23. Preferably, the front surface 44 of the structural panels 43 extends substantially flush with the back of the tiles. In this respect, the front of the panels 43 is preferably flush with the snap-in fillers 67, so that the tiles 23 can be secured to both the structural panels 43 and the framing members 3 and 5 along substantially the same plane. Each tile 23 is preferably sized to extend beyond the outer edges of the structural panels 43 and to overlap the front of the mullions 3 and 5, so that there is an adequate margin for the tiles 23 to be secured to the mullions 3 and 5. Because each tile 23 is supported by the structural panels 43 from behind, and structural silicone 24 is provided at regular intervals between the tiles 23 and panels 43, and interior gaskets 51 are used to seal the spaces between the tiles 23 and mullions 3 and 5, side loads caused by debris and heavy wind pressure is absorbed by the materials (from which the silicone 24 and gaskets 51 are made), and supported laterally by the structural panels 43 and frame 1. This increases the curtain wall's ability to resist lateral loads caused by wind and debris, and therefore, helps to satisfy the strict building code requirements that exist in certain areas of the country.

The tiles 23 are preferably made of porcelain or other ceramic material, and, because of the support provided by the frame 1, they can be made relatively thin, i.e., a minimum of about ⅜ inch thick. Each tile 23 is preferably cut and sized to cover the spaces formed by the horizontal 3 and vertical 5 mullions, and therefore, has a maximum surface area of about 9 square feet. The tiles 23 are also preferably provided with designs, colors and/or patterns that are aesthetically pleasing, and can be polished so that they are smooth to the touch.

The frame 1 is required to be properly supported and anchored to the building on which the curtain wall is built, to help transfer the lateral loads from the walls to the building. For example, the frame 1 can be mounted and supported by upper and lower building structures, 29 and 30, respectively, which can be made of concrete, wood, metal or other building material. Along the top of the frame, as shown in FIG. 2, anchors 12 can be embedded or otherwise secured to the upper building structure 29, such that connecting angles 15 can be mounted thereto. The angles 15 can be extended from the upper building structure 29, and can have flanges 14 on which fasteners 13, such as nuts and bolts, can be used to secure the horizontal mullions 3 to the building structure 29. Along the bottom of the frame 1, threaded anchors 16 can be embedded or otherwise secured directly to the lower building structure 30. The anchors 16 are preferably extended upward to enable the lower horizontal mullions 3 to be secured to the building structure 30 using fasteners and nuts 16 as shown.

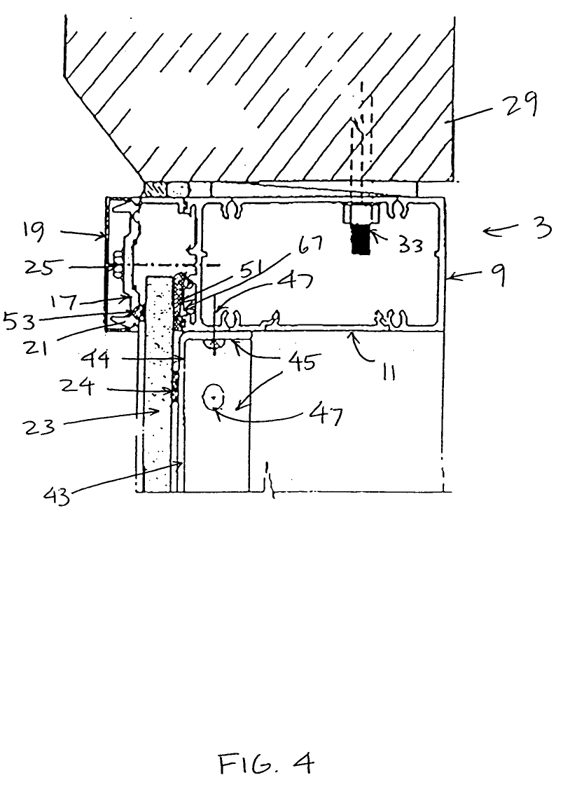

In FIG. 4, an alternative method of securing the horizontal mullions 3 to the upper building structure 29 is shown. In this embodiment, threaded anchors 33 are used to directly secure the mullions 3 to the building structure 29 with nuts. As discussed previously, the ability to remove cover plate 11 from the tube portion 9 enables workers to access the interior of the mullion 3 to secure the nut on the anchor 33. Any other method of anchoring the frame can be used. An exterior gasket or sealant 27 is preferably provided between the mullions 3, and the building structures 29 and 30, to seal the spaces therebetween. A backer rod 31 can also be used to provide support for the spacings.

On the sides, as shown in FIG. 3, the frame 1 is preferably positioned between two side building structures 61 and 63. An exterior gasket or sealant 28 is preferably provided between the mullions 5, and the building structures 61 and 63, to seal the spaces therebetween and provide lateral support for the frame 1. Additional backer rods 31 can also be used to provide support for the spacings.

Additional intermediate supports 55 and 57 can be provided to secure the frame 1 to the building and transfer lateral loads from the curtain walls, as shown in FIGS. 2 and 7, to the building. In this respect, frame 1 can be connected to an intermediate building support 55, using an extended structure, such as an angle 57, anchored thereto, to provide bracing for the wall. The building support 55 can, for example, be an intermediate floor, such as where the frame 1 extends to a height greater than the height of a single floor. The angle 57 extending from the building support 55 is preferably connected to the vertical mullions 5 using through-bolts and slotted holes 65, as shown in FIG. 2.

The advantage of the curtain wall of the present invention is that lateral design load capacities are increased to meet the stringent requirements that exist in certain areas of the country where the threat of hurricane damage is high. For example, using the preferred construction described above, it is possible to satisfy the maximum design load capacity of 75 pounds per square foot imposed by the South Florida Buidling Code for Dade County. The structure is also designed to meet the wind loads per the latest version ASCE 7 using corresponding loads. These requirements were satisfied using a mullion spacing of three feet (for both horizontal and vertical members), a frame height of up to 156 inches, and a bracing to transfer loads from the wall to an intermediate building support structure.

The invention has been discussed in terms of the preferred embodiments but should not be viewed as being limited thereby. The invention encompasses embodiments that are not specifically disclosed herein, but which are, nevertheless, covered by the claims.

What is claimed is:

1. A curtain wall structure comprising:
horizontal mullions spaced a predetermined distance apart from each other, and vertical mullions spaced a predetermined distance apart from each other, wherein said horizontal and vertical mullions are connected together to form a frame having a plurality of openings therein;
support panels made of a light weight material connected to said frame, said panels extending across said openings; and
tiles positioned on said frame, each of said tiles being adapted to be positioned on the front side of said panels, wherein structural silicon is used to secure said tiles to said panels.

2. The structure of claim 1, wherein each of said support panels has an angled edge that extends around the perimeter thereof, said angled edge being adapted to secure said panels to said frame and provide rigidity to said panels.

3. The structure of claim 1, wherein said support panels have a front surface that extends substantially along the same plane as the front surface of said frame.

4. The structure of claim 2, wherein fasteners are used to secure said angled edge of said panels to said horizontal and vertical mullions.

5. The structure of claim 1, wherein a gasket is provided between the perimeter of said tiles and said frame to seal the space between said tiles and said frame.

6. The structure of claim 1, wherein a top retainer is provided along the upper edge of said frame to retain the tiles that are located on the upper part of said frame, said top retainer being connected to said upper edge of said frame along one of said horizontal mullions, and wherein a bottom retainer is provided along the lower edge of said frame to retain the tiles that are located on the lower part of said frame, said bottom retainer being connected to said lower edge of said frame along another of said horizontal mullions.

7. The structure of claim 1, wherein in the space between adjacent tiles gaskets or sealants are provided to form a seal between said tiles and said frame.

8. The structure of claim 1, wherein each of said tiles has dimensions in the horizontal and vertical directions that are greater than the distances between the horizontal and vertical mullions, respectively, and wherein each of said support panels has dimensions in the horizonal and vertical directions that are substantially the same as the distances between the horizontal and vertical mullions, respectively.

9. The structure of claim 1, wherein said panels have a first predetermined thickness, and said tiles have a second predetermined thickness, wherein said second predetermined thickness is greater than said first predetermined thickness.

10. The structure of claim 9, wherein each of said support panels has a horizontal edge portion extending around the perimeter that has a rearward dimension that is greater than said second predetermined thickness.

11. The structure of claim 1, wherein said tiles are made of porcelain or ceramic material.

12. The structure of claim 10, wherein said tiles are no thinner than about three eighths of an inch thick, and said support panels are made of aluminum that is about one eighth inch thick.

13. A curtain wall structure comprising:
horizontal and vertical mullions spaced apart from each other, wherein said horizontal and vertical mullions are connected together to form a frame having a plurality of openings therein;
support panels connected to said frame, each of said panels having substantially the same size and shape as said openings, and having a perimeter edge extending normal to a front surface thereof, wherein said front surface of said panels extends along a plane that is substantially the same as or in front of the front surface of said frame; and
tiles connected to said frame and said panels, wherein structural silicon is used to secure said tiles to said panels.

14. The structure of claim 13, wherein each of said panels and tiles is larger in the horizontal and vertical dimensions than said openings, and wherein said panels are connected to said frame along the perimeter edge thereof.

15. A method of forming a curtain wall comprising:
providing a frame having horizontal and vertical mullions spaced apart from each other, said horizontal and vertical mullions forming a plurality of openings therein;
connecting a plurality of support panels made of a light weight material onto said frame, said panels being positioned on said frame within said openings, wherein each of said panels has substantially the same size and shape as said openings, and has a front surface that extends along a plane that is substantially the same as, or in front of, the front surface of said frame; and
applying structural silicon to said panels and attaching tiles onto said panels using said structural silicon.
